(19) United States
(12) Patent Application Publication
(10) Pub. No.: US 2025/0061188 A1
(43) Pub. Date: Feb. 20, 2025

(54) COMPUTER-IMPLEMENTED METHOD FOR IMPROVING DATA SECURITY IN A COMPUTING DEVICE

(71) Applicants: Continental Automotive Technologies GmbH, Hannover (DE); Nanyang Technological University, Singapore (SG)

(72) Inventors: Jingquan Ge, Singapore (SG); Etienne Alcide Sapin, Singapore (SG); Suraj Jayakumar Menon, Singapore (SG); Sheikh Habib Mahbub, Darmstadt (DE); Praveen Kakkolangara, Singapore (SG); Yaowen Zheng, Singapore (SG); Yang Liu, Singapore (SG); Zhengjie Du, Singapore (SG); Xinliang Zhou, Singapore (SG)

(73) Assignees: Continental Automotive Technologies GmbH, Hannover (DE); Nanyang Technological University, Singapore (SG)

(21) Appl. No.: 18/806,919

(22) Filed: Aug. 16, 2024

(30) Foreign Application Priority Data
Aug. 17, 2023 (DE) 102023207909.7

(51) Int. Cl. G06F 21/53; G06F 21/54

(52) U.S. Cl. CPC G06F 21/53; G06F 21/54

(57) ABSTRACT

The invention relates to a computer-implemented method for improving data security in a computing device (10), the computing device (10) including a computer system (12) with a processor (16) for executing computer instructions (18) and a physical memory (20) accessible to the processor (16), the computer system (12) being configured as an implementation of a computer architecture suitable for switching between a trusted execution environment (22) for executing a trusted computing process (24) and a rich execution environment (26) for executing a client computing process (28) corresponding to the trusted computing process (24), wherein an access of the rich execution environment (26) on the trusted execution environment (22) is restricted and/or secured, wherein the rich execution environment (26) and the trusted execution environment (24) respectively are switchable between a user mode (30) in which execution of one or more selected computer instructions (18) for accessing the physical memory (20) is restricted and/or secured, and a kernel mode (32) in which execution of said computer instructions (18) is unrestricted and/or unsecured, wherein the rich execution environment (26) and the trusted execution environment (24) commonly use a shared memory (34) of the physical memory (20), the shared memory (34) providing a communication channel (36) including related process data (38) for communication between the client computing process (28) and the trusted computing process (24).

### CROSS REFERENCE TO RELATED APPLICATIONS

This application claims priority to German Patent Application No. 10 2023 207 909.7, filed Aug. 17, 2023, the contents of such application being incorporated by reference herein.

### FIELD OF THE INVENTION

The invention relates to a computer-implemented method for improving data security in a computing device. The invention further relates to a computing device, a computer program, and a computer-readable storage medium.

### BACKGROUND OF THE INVENTION

In recent years, ARM©-based electronic devices have flooded the market. These products have been deeply integrated into daily life, so that they inevitably store or process sensitive privacy data. To protect these data, ARM® TrustZone®-based Trusted Execution Environment (TEE) was proposed and continuously enhanced. Nowadays, as consumers pay more attention to information security, the application scenarios of TrustZone®-based TEE are not limited to common ARM®-based devices such as smartphones and tablets. Various types of IoT and embedded devices, including drones and vehicle electronic equipment, have begun to deploy TEE in their systems.

TrustZone®-based TEE is isolated from the Rich Execution Environment (REE), so that attackers in the REE cannot access resources of TEE directly. The normal applications run in REE while the Trusted Applications (TAs) are executed in TEE. The only way for an REE process to access the resources of TEE is to invoke TAs. Each TA has a corresponding client application (CA) in REE. To access the resources of TEE, a CA process needs to create its own communication channel to exchange data with the corresponding TA. Normally, this channel is established based on the shared memory which can be accessed by both REE and TEE. However, the communication channel may not be secure when REE OS kernel is untrusted. Many researchers have successfully exploited this type of vulnerabilities. Even without the kernel privilege, attackers in user space can deceive the TAs to process deliberately crafted data in the fake memory addresses. Worse still, the REE OS kernel can access physical addresses freely due to the existence of the Physmap mechanism. Therefore, the data in these communication channels may be easily stolen or tampered with by the untrusted REE OS kernel (e.g., man-in-the-middle attack).

To protect the communication channel between TEE and REE, researchers have proposed several software defense schemes. However, these software defense schemes may be either not secure enough or have too much performance overhead. Benefiting from the special architecture combining hardware and software, ARM©-FPGA embedded SoC has been widely used in drones, vehicle electronic equipment, machine vision systems and other IoT devices. Like smartphones and tablets, these security-sensitive devices also require TrustZone®-based TEE to protect sensitive data. Since both, the software and hardware on the ARM©-FPGA embedded SoC, can be freely programmed, it provides researchers with more possibilities to implement secure and efficient hardware/software codesign for TEE.

### SUMMARY OF THE INVENTION

An aspect of the invention aims to improve the data security in a computing device.

In one aspect, the invention provides a computer-implemented method for improving data security in a computing device, the computing device including a computer system with a processor for executing computer instructions and a physical memory accessible to the processor, the computer system being configured as an implementation of a computer architecture suitable for switching between a trusted execution environment for executing a trusted computing process and a rich execution environment for executing a client computing process corresponding to the trusted computing process, wherein an access of the rich execution environment on the trusted execution environment is restricted and/or secured, wherein the rich execution environment and the trusted execution environment respectively are switchable between a user mode in which execution of one or more selected computer instructions for accessing the physical memory is restricted and/or secured, and a kernel mode in which execution of said computer instructions is unrestricted and/or unsecured, wherein the rich execution environment and the trusted execution environment commonly use a shared memory of the physical memory, the shared memory providing a communication channel including related process data for communication between the client computing process and the trusted computing process, the method comprising:
a) by the computing device, providing a restricted memory, wherein the access to the restricted memory is restricted and/or secured with respect to the processor;
b) by the computer system, upon receiving a computer instruction for switching from the user mode to the kernel mode inside the rich execution environment, triggering the computing device to perform the following:
α) transferring the related process data from the shared memory into the restricted memory by clearing the related process data in the shared memory; and
c) by the computing device, performing step α).

An advantage of the method may be that once the computer system switches from the user mode to the kernel mode inside the rich execution environment, sensitive data that may be accessible in the kernel mode of the rich execution environment, is cleared in the shared memory. Thus, this sensitive data cannot be read and/or manipulated in the kernel mode of the rich execution environment. This increases the data security of the computing device.

Preferably, the method further comprises:
d) by the computer system, upon receiving a computer instruction for switching from the kernel mode of the trusted execution environment to the kernel mode of the rich execution environment, triggering the computing device to perform step α); and
e) by the computing device, performing step α).

An advantage of the method may be that both ways of switching to the kernel mode of the rich execution environment may be secured. Thus, even when switching from the kernel mode of the trusted execution environment to the kernel mode of the rich execution environment, sensitive data that may be accessible in the kernel mode of the rich execution environment, is cleared in the shared memory. Thus, this sensitive data cannot be read and/or manipulated in the kernel mode of the rich execution environment. This increases the data security of the computing device.

Preferably, the method further comprises:
f) storing a physical location for localizing the communication channel in the physical memory and clearing the related process data in the shared memory by localizing the communication channel in the physical memory based on the physical location.

An advantage of the method may be that a physical location of the communication channel may be stored. An attack may be to move sensitive data that is located at a first physical location to a second physical location in the shared memory such that clearing the first physical location will not clear the sensitive data in the shared memory. Therefore, the physical location may be stored elsewhere than in the computer system. For example, the physical location may be stored in the restricted memory. This may guarantee that the sensitive data is cleared properly. This increases the data security of the computing device.

Preferably, the method further comprises:
g) by the computer system, upon receiving a computer instruction for switching from the kernel mode to the user mode inside the rich execution environment, triggering the computing device to perform the following:
β) transferring the related process data from the restricted memory into the communication channel of the shared memory by identifying the client computing process in the rich execution environment; and
h) by the computing device, performing step β).

An advantage of the method may be that the sensitive data may be restored in the shared memory as soon as the computer system switches to the user mode of the rich execution environment. In the user mode of the rich execution environment, accessing the sensitive data may not be possible. Thus, the client computing process can resume working as before the computer system switched to the kernel mode of the rich execution environment. This increases the reliability of the computing device.

Preferably, the method further comprises:
i) by the computer system, upon receiving a computer instruction for switching from the kernel mode of the rich execution environment to the kernel mode of the trusted execution environment, triggering the computing device to perform the following:
β) transferring the related process data from the restricted memory into the communication channel of the shared memory by identifying the client computing process in the rich execution environment; and
j) by the computing device, performing step β).

An advantage of the method may be that the sensitive data may be restored in the shared memory as soon as the computer system switches to the kernel mode of the trusted execution environment. In the kernel mode of the trusted execution environment, accessing the sensitive data may be possible, since trustworthy. It may also be possible to switch from the kernel mode of the trusted execution environment to the user mode of the trusted execution environment. Thus, the trusted computing process can resume working as before the computer system switched to the kernel mode of the rich execution environment. This increases the reliability of the computing device.

Preferably, the method further comprises:
k) storing a process identifier for identifying the client computing process in the rich execution environment and identifying the client computing process in the rich execution environment based on the process identifier.

An advantage of the method may be that a process identifier of the client computing process may be stored. An attack may be to redirect sensitive data that is to be transferred from the restricted memory into a first communication channel, to a second communication channel in the shared memory. Therefore, the process identifier may be stored elsewhere than in the computer system. For example, the process identifier may be stored in the restricted memory. This may guarantee that the sensitive data is restored in the correct communication channel between the correct client/trusted computing processes. This increases the data security of the computing device.

Preferably, the method further comprises:
l) monitoring an integrity of a computer instruction for triggering the computing device to transfer the related process data into or out of the restricted memory, preferably by calculating a hash of said computer instruction, and transferring the related process data into or out of the restricted memory based on the monitored integrity.

An advantage of the method may be that an integrity of the computer instruction for triggering the computing device to transfer the related process data into or out of the restricted memory may be monitored. The monitoring may be performed from elsewhere than in the computer system. Thus, the computing device may not be deceived by manipulation of the computer instructions for triggering the computing device to transfer. This increases the data security of the computing device.

In another aspect, the invention provides a computing device including a computer system with a processor for executing computer instructions and a physical memory accessible to the processor, the computer system being configured as an implementation of a computer architecture suitable for switching between a trusted execution environment for executing a trusted computing process and a rich execution environment for executing a client computing process corresponding to the trusted computing process, wherein an access of the rich execution environment on the trusted execution environment is restricted and/or secured, wherein the rich execution environment and the trusted execution environment respectively are switchable between a user mode in which execution of one or more selected computer instructions for accessing the physical memory is restricted and/or secured, and a kernel mode in which execution of said computer instructions is unrestricted and/or unsecured, wherein the rich execution environment and the trusted execution environment commonly use a shared memory of the physical memory, the shared memory providing a communication channel including related process data for communication between the client computing process and the trusted computing process, wherein the computing device provides a restricted memory, wherein the access to the restricted memory is restricted and/or secured with respect to the processor, and wherein the computing device is adapted to perform the method according to any of the preceding embodiments.

Preferably, hardware of the computing device is adapted to perform one, several or all of the following:
α) transferring the related process data from the shared memory into the restricted memory by clearing the related process data in the shared memory; and/or
β) transferring the related process data from the restricted memory into the communication channel of the shared memory by identifying the client computing process in the rich execution environment; and/or
f) storing a physical location for localizing the communication channel in the physical memory and clearing the related process data in the shared memory by localizing the communication channel in the physical memory based on the physical location; and/or
k) storing a process identifier for identifying the client computing process in the rich execution environment and identifying the client computing process in the rich execution environment based on the process identifier; and/or
l) monitoring an integrity of a computer instruction for triggering the computing device to transfer the related process data into or out of the restricted memory, preferably by calculating a hash of said computer instruction, and transferring the related process data into or out of the restricted memory based on the monitored integrity.

An advantage of the computing device may be that modules that are relevant for data security, may be implemented in hardware. Thus, the computing device may not be deceived by attack originating from software. This increases the data security of the computing system.

Preferably, the computing device includes a field-programmable gate array providing the restricted memory.

Preferably, the field-programmable gate array is adapted to perform one, several or all of the steps α), β), f), k), and/or l).

An advantage of the computing device may be that modules that are relevant for data security, may be implemented separated from the computer system. Thus, the computing device may not be deceived by attack originating from the computer system. This increases the data security of the computing system.

Preferably, software of the computing device is adapted for triggering the computing device to perform the step α) and/or β).

An advantage of the computing device may be that modules may be implemented in software. Thus, there may be no need to modify the existing computer architecture of the computing device, instead the latter can be used efficiently, for example, by employing one or more hook functions. This increases the efficiency of the computing device.

Preferably, the computer system is adapted for triggering the field-programmable gate array to perform the step α) and/or β).

An advantage of the computing device may be that modules may be implemented in the computer system. Thus, the hardware modules are implemented in the field-programmable gate array, while the software modules are implemented in the computer system separated from the hardware modules. The hardware-based modules and the software-based modules can further be adapted to communicate or collaborate with each other. This may provide a safe, efficient, and/or reliable computing device.

Preferably, the computer system is configured as an implementation of a reduced instruction set computer instruction set architecture.

Features and advantages that are mentioned with respect to the method may also be applied to the computing device, and features and advantages that are mentioned with respect to the computing device may also be applied to the method.

In another aspect, the invention provides a computer program comprising instructions which, when the program is executed by the computing device according to any of the preceding embodiments, cause the computing device to carry out the method according to any of the preceding embodiments.

In another aspect, the invention provides a computer-readable storage medium having stored thereon the computer program.

Embodiments of the invention preferably have the following advantages and effects:
To protect the communication channel of TrustZone®-based TEE, preferred embodiments of the invention propose “PumpChannel,” preferably a hardware-software collaborative design on ARM©-FPGA embedded SoC.

“PumpChannel” consists of a pump in hardware and hooks in software, which can pull/push the sensitive data out of/into the communication channel. When a CPU core enters REE kernel mode from REE user mode or TEE, the data are pumped from the communication channel into the memory owned by “PumpChannel.” They will be pumped from the memory owned by “PumpChannel” into the communication channel when a CPU core enters TEE or returns to REE user mode from REE kernel mode. Therefore, the malicious REE kernel cannot steal or tamper with sensitive data in the communication channel.

“PumpChannel” preferably is a hardware-software collaborative design to protect TEE communication on ARM©-FPGA embedded SoC. It preferably provides a secure communication mechanism for TEE, which can stop the untrusted REE kernel from accessing the communication channel. To ensure the integrity of all the hooks, “PumpChannel” preferably has a hook integrity monitor in the hardware, which can continuously check whether the code segment of each hook has been modified.

Since “PumpChannel” may avoid security vulnerabilities caused by using secret keys, its communication memory may be more secure than the existing encryption defense schemes. Furthermore, since “PumpChannel” preferably uses hardware to monitor the hook's code integrity in real time, its code memory may be more secure than the existing solutions. Furthermore, “PumpChannel” preferably utilizes hardware-software co-design to protect the communication channel of TEE, which has lower performance overhead than existing encryption solutions.

The security of vehicle systems has increasingly become the focus of attention in the automotive industry. On the other hand, ARM©-FPGA embedded SoC has been widely used in vehicle systems. Therefore, in-vehicle system manufacturers may be interested in the technology of “PumpChannel.” Second, the hardware module designed by “PumpChannel” in FPGA can assist the security function of CPU. This idea cannot only be used on ARM©-FPGA embedded SoC, but also may be provide a more secure design idea for processor designers. Therefore, processor design manufacturers are also potential users of “PumpChannel.”

### BRIEF DESCRIPTION OF THE DRAWINGS

Embodiments of the invention are now explained in more detail with reference to the accompanying drawings of which

FIG. 1 shows an embodiment of a computing device;

FIG. 2 shows an embodiment of a method for improving data security in the computing device; and

FIG. 3 shows a flow diagram of the method.

### DETAILED DESCRIPTION OF EXEMPLARY EMBODIMENTS

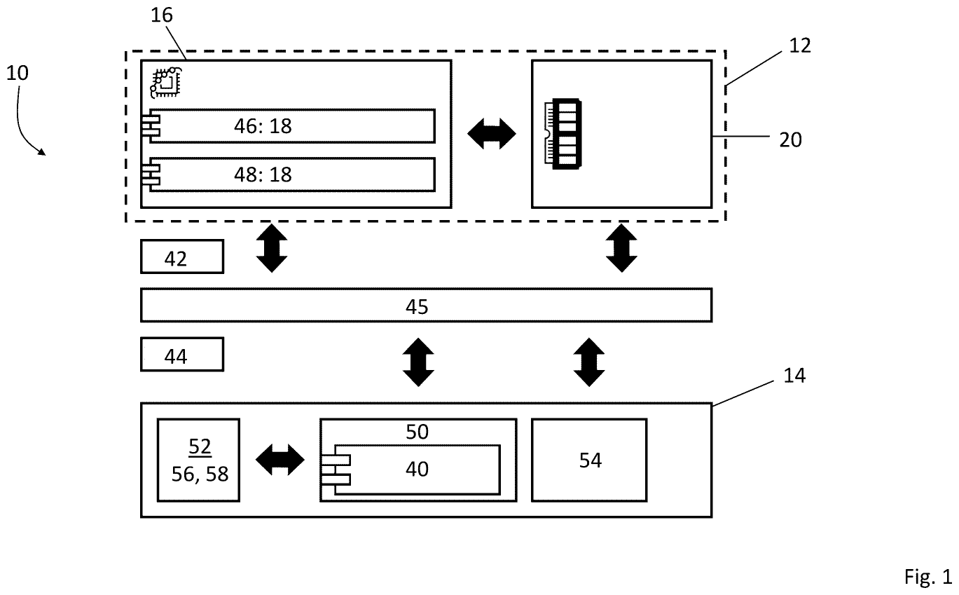

FIG. 1 shows an embodiment of a computing device 10.

The computing device 10 includes a computer system 12 and a field-programmable gate array 14.

The computer system 12 includes a processor 16 for executing computer instructions 18 and a physical memory 20 accessible to the processor 16.

The computer system 12 is configured as an implementation of a computer architecture suitable for switching between a trusted execution environment 22 for executing a trusted computing process 24 and a rich execution environment 26 for executing a client computing process 28 corresponding to the trusted computing process 24. An access of the rich execution environment 26 on the trusted execution environment 22 is restricted and/or secured. In other words, the access of the rich execution environment 26 on the trusted execution environment 22 may not be possible. An example of such a computer system 12 is ARM® Cortex®-A53 with the computer architecture including TrustZone®.

In the computer system 12, the rich execution environment 26 and the trusted execution environment 22 respectively are switchable between a user mode 30 in which execution of one or more selected computer instructions 18 for accessing the physical memory 20 is restricted and/or secured, and a kernel mode 32 in which execution of said computer instructions 18 is unrestricted and/or unsecured. In other words, in the user mode 30, the execution of said computer instructions 18 may not be possible.

The physical memory 20 includes a shared memory 34 which is commonly used by the rich execution environment 26 and the trusted execution environment 22. The shared memory 34 provides a communication channel 36 including related process data 38 for communication between the client computing process 28 and the trusted computing process 24.

The computing device 10 further includes a restricted memory 40, wherein the access to the restricted memory 40 is restricted and/or secured with respect to the processor 16. In other words, the access of the processor 16 to the restricted memory 40 may not be possible. In the embodiment as shown in FIG. 1, the restricted memory 40 is included in the field-programmable gate array 14.

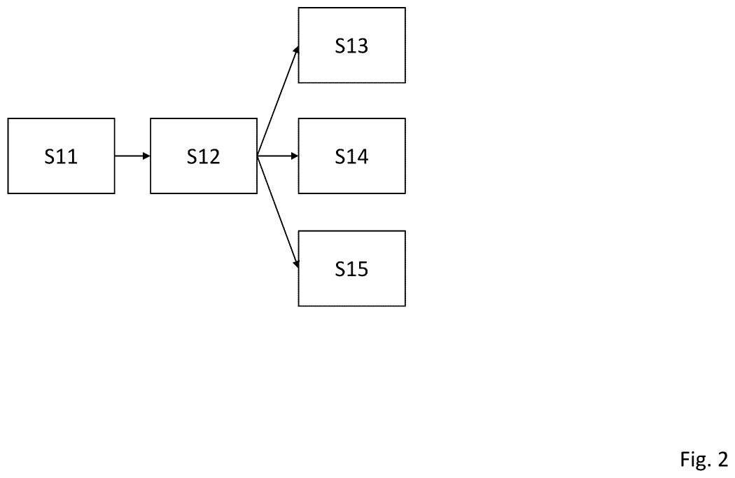

FIG. 2 shows an embodiment of a method for improving data security in the computing device 10.

In a step S11, the method includes:
by the computing device 10, providing the restricted memory 40, wherein the access to the restricted memory 40 is restricted and/or secured with respect to the processor 16.

In a step S12, the method includes:
by the computer system 12, upon receiving a computer instruction 18 for switching from the user mode 30 to the kernel mode 32 inside the rich execution environment 26, triggering the computing device 10 to perform the following:
α) transferring the related process data 38 from the shared memory 34 into the restricted memory 40 by clearing the related process data 38 in the shared memory 34; and
by the computing device 10, performing step α).

In a step S13, the method includes:
by the computer system 12, upon receiving a computer instruction 18 for switching from the kernel mode 32 of the trusted execution environment 22 to the kernel mode 32 of the rich execution environment 26, triggering the computing device 10 to perform step α); and
by the computing device 10, performing step α).

In a step S14, the method includes:
by the computer system 12, upon receiving a computer instruction 18 for switching from the kernel mode 32 to the user mode 30 inside the rich execution environment 26, triggering the computing device 10 to perform the following:
β) transferring the related process data 38 from the restricted memory 40 into the communication channel 36 of the shared memory 34 by identifying the client computing process 28; and
by the computing device 10, performing step β).

In a step S15, the method includes:
by the computer system 12, upon receiving a computer instruction 18 for switching from the kernel mode 32 of the rich execution environment 26 to the kernel mode 32 of the trusted execution environment 22, triggering the computing device 10 to perform step β); and
by the computing device 10, performing step β).

Reference is made again to FIG. 1:

The method according to FIG. 2 is implemented in the computing device 10 in software 42 and hardware 44.

For this, the computer system 12 and the field-programmable gate array 14 are connected via a bus 45 for communication between software 42 and hardware 44.

The computer system 12 includes a first trigger module 46 and a second trigger module 48 each having one or more computer instructions 18 that are implemented in software 42 in the processor 16. The one or more computer instructions 18 may, for example, be configured as a hook function, respectively.

The field-programmable gate array 14 includes a transfer module 50 (Pump Machine) that is implemented in hardware 44 of the field-programmable gate array 14. The transfer module 50 is adapted to perform the steps α) and β) and includes the restricted memory 40 (PumpChannel Memory).

The first trigger module 46 (Mode Switch Hooks) and the second trigger module 48 (Environment Switch Hooks) are configured for triggering the transfer module 50. The first trigger module 46 triggers the transfer module 50 upon receiving, by the processor 16, a computer instruction 18 for switching from the user mode 30 to the kernel mode 32 or vice versa. The second trigger module 46 triggers the transfer module 50 upon receiving, by the processor 16, a computer instruction 18 for switching from the rich execution environment 26 to the trusted execution environment 22 or vice versa.

The field-programmable gate array 14 as shown in FIG. 1 further includes a channel module 52 (Channel Mapper) and an integrity module 54 (Hook Integrity Monitor) that are implemented in hardware 44 in the field-programmable gate array 14.

The channel module 52 is adapted to store a physical location 56 for localizing the communication channel 36 in the physical memory 20. The physical location 56 may, for example, be a physical address of the communication channel 36 in the physical memory 20.

The channel module 52 is further adapted to store a process identifier 58 for identifying the client computing process 28 in the rich execution environment 26. The process identifier 58 may, for example, be a PID of the client computing process 28 in the rich execution environment 26.

The transfer module 50 communicates with the channel module 52 for clearing the related process data 38 in the shared memory 34 according to step α) by localizing the communication channel 36 in the physical memory 20 based on the physical location 56 stored in the channel module 52. The clearing may, for example, be performed by overwriting the related process data 38 with zeros.

The transfer module 50 communicates with channel module 52 for identifying the client computing process 28 in the rich execution environment 26 according to step 3) by identifying the client computing process 28 in the rich execution environment 26 based on the process identifier 58 stored in the channel module 52.

The integrity module 54 is adapted to monitor an integrity of the first trigger module 46 and the second trigger module 48. The integrity module 54 may, for example, calculate a hash of the first trigger module 46, the second trigger module 48, and/or one or more computer instructions 18 thereof. The integrity module 54 may further continuously or periodically check the integrity of the first trigger module 46 and the second trigger module 48. For example, if the integrity module 54 determines that the first trigger module 46 and/or the second trigger module 48 have been modified, the integrity module 54 may correct them, preferably immediately or in real time. The transfer module 50 communicates with the integrity module 54 for performing step α) and/or β) based on the integrity monitored by the integrity module 54.

Preferred embodiments of the invention may be described as follows:

### Hardware Modules of “PumpChannel”:

Channel module 52 (Channel Mapper): the current→pid of the legal client application (CA) and the physical addresses of the corresponding communication channel 36 are stored in it. The purpose of storing current→pid is to allow the legitimate CA process to only access their own communication channel 36.
Transfer module 50 (Pump Machine): it pumps the related process data 38 (sensitive data) into or out of the communication channel 36 according to the client computing process 28 information and address information stored in the channel module 52 (Channel Mapper).
Restricted memory 40 (PumpChannel Memory): this memory is implemented based on the block RAM of the FPGA and utilized to temporarily store sensitive data pumped out of the communication channel 36.
Integrity module 54 (Hook Integrity Monitor): it can monitor whether the code segment of every trigger module 46, 48 (every hook function) has been modified.

Software modules of PumpChannel:
First trigger module 46 (Mode Switch Hooks): it includes two hooks, i.e., a user-kernel hook and a kernel-user hook. The mode switch from user mode 30 to kernel mode 32 of each CPU core is hooked by the user-kernel hook. The kernel-user hook hooks the opposite mode switch. The two hooks trigger the transfer module 50 (Pump Machine) to pump data into or out of the communication channel 36.
Second trigger module 48 (Environment Switch Hooks): it includes two hooks, REE-TEE hook and TEE-REE hook. The environment switch from the rich execution environment 26 (REE) to the trusted execution environment 22 (TEE) is hooked by REE-TEE hook. The opposite environment switch is hooked by TEE-REE hook. The transfer module 50 (Pump Machine) can be triggered by the two hooks to pump data into or out of the communication channel 36.

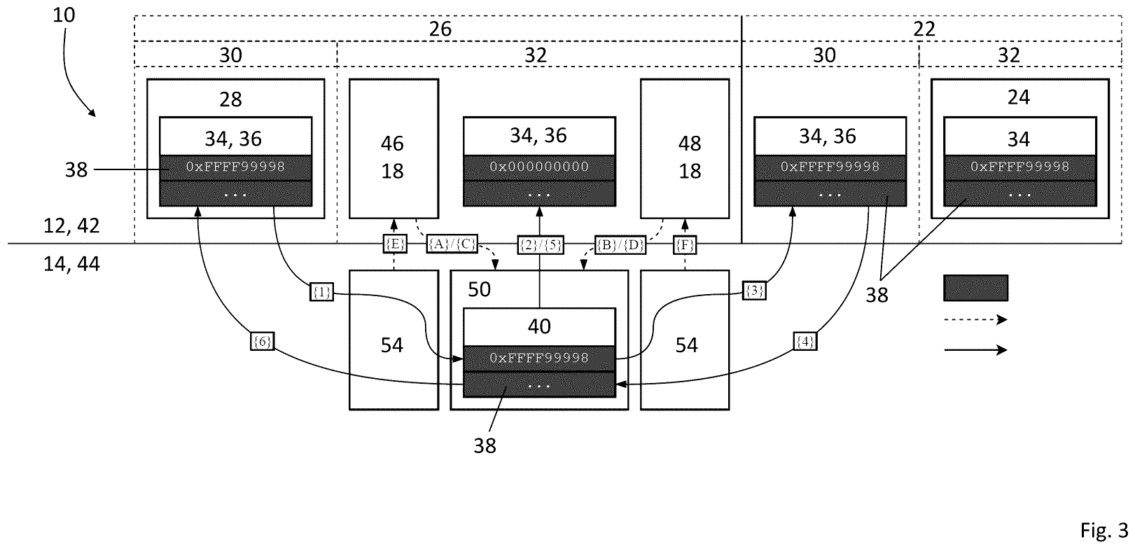

FIG. 3 shows a flow diagram of the method.

The computing device 10 is divided into four states, which are the user mode 30 of the rich execution environment 26, the kernel mode 32 of the rich execution environment 26, the kernel mode 32 of the trusted execution environment 22, and the user mode 30 of the trusted execution environment 22.

The first trigger module 46 (Mode Switch Hooks) is in the middle of the user mode 30 of the rich execution environment 26 (REE) and the kernel mode 32 of the rich execution environment 26 (REE) to hook the switch of these two states.

The second trigger module 48 (Environment Switch Hooks) is in the middle of the kernel mode 32 of the rich execution environment 26 (REE) and the kernel mode 32 of the trusted execution environment 22 (TEE) to hook the switch between TEE 22 and REE 26.

Both, the data flow (solid arrow) and the control flow (dashed arrow) of the entire design have six steps involving a data page (in black):

REE 26 user mode 30→REE 26 kernel mode 32:
When the computer system 12 switches from REE 26 user mode 30 to REE 26 kernel mode 32, step {A},{1} and {2} will be executed.
{A}: The first trigger module 46 (user-kernel hook) sends pump out signal to transfer module 50 (Pump Machine). The pump out signal can trigger the transfer module 50 (Pump Machine) to pump the related process data 38.
{1}: When the transfer module 50 (Pump Machine) receives pump out signal, it pumps the related process data 38 (sensitive data) out of all communication channels 36 and stores it into the restricted memory 40 (PumpChannel Memory). {2}: After step {1} is completed, the transfer module 50 (Pump Machine) clears the related communication data 38 of all communication channels 36 to zero.

REE 26 kernel mode 32→REE 26 user mode 30:
Step {C} and {6} will run when the computer system 12 switches from REE 26 kernel mode 32 to REE 26 user mode 30.
{C}: The first trigger module 50 (kernel-user hook) sends pump in signal and current→pid signal to the transfer module 50 (Pump Machine). The pump in signal can trigger the transfer module 50 (Pump Machine) to pump the related process data 38.
{6}: When the transfer module 50 (Pump Machine) receives the pump in signal and the current→pid signal, it will pump the related process data 38 (sensitive data) of the current client computing process 28 from the restricted memory 40 (PumpChannel Memory) into the communication channel 36 of the current client computing process 28.

REE 26 kernel mode 32→TEE 22 kernel mode 32:
When REE 26 kernel mode 32 switches to TEE 22 kernel mode 32, step {B} and {3} will run.
{B}: Same as step {C}(kernel-user hook), the second trigger module 48 (REE-TEE hook) sends the pump in signal and the current→pid signal to the transfer module 50 (Pump Machine).
{3}: When the pump in signal and the current→pid signal are received by the transfer module 50 (Pump Machine), the related process data 38 (sensitive data) of the current client computing process 28 will be pumped by the transfer module 50 (Pump Machine) from the restricted memory 40 (PumpChannel Memory) into the communication channel 36 of the current client computing process 28.

TEE 22 kernel mode 32→REE 26 kernel mode 32:
When the computer system 12 switches from TEE 22 kernel mode 32 to REE 26 kernel mode 32, step {D}, {4} and {5} will be executed.
{D}: The second trigger module 48 (TEE-REE hook) sends the pump out signal to the transfer module 50 (Pump Machine).
{4}: When the pump out signal reaches the transfer module 50 (Pump Machine), the related process data 38 (sensitive data) will be pumped out of all the communication channels 36 and stored into the restricted memory 40 (PumpChannel Memory) by the transfer module 50 (Pump Machine).
{5}: After step {4}, the transfer module 50 (Pump Machine) zeros the physical location 56 (addresses) of all the communication channels 36.

### (Hook) Integrity:

Step {E} and {F} are to ensure the integrity of the first trigger module 46 and the second trigger module 48 (all the hooks) in “PumpChannel's” design.
{E}: The integrity module 54 (Hook Integrity Monitor) cyclically checks the static code segment of the first trigger module 46 (Mode Switch Hooks) and calculates the hash value. If it is found that the code segment of the first trigger module 46 (Mode Switch Hooks) has been modified, the integrity module 54 (Hook Integrity Monitor) will correct it immediately.
{F}: Same as step {E}, the integrity module 54 (Hook Integrity Monitor) will check the static code segment of second trigger module 48 (Environment Switch Hooks) cyclically and correct it in real time.

An aspect of the invention also provides a computer program (not shown) comprising instructions which, when the program is executed by the described computing device 10, cause the computing device 10 to carry out the described method. An aspect of the invention further provides a computer-readable storage medium (not shown) having stored thereon the computer program.

### REFERENCE SIGNS

10 computing device
12 computer system
14 field-programmable gate array
16 processor
18 computer instruction
20 physical memory
22 trusted execution environment
24 trusted computing process
26 rich execution environment
28 client computing process
30 user mode
32 kernel mode
34 shared memory
36 communication channel
38 related process data
40 restricted memory
42 software
44 hardware
45 bus
46 first trigger module
48 second trigger module
50 transfer module
52 channel module
54 integrity module
56 physical location
58 process identifier

1. A computer-implemented method for improving data security in a computing, the computing device including a computer system with a processor for executing computer instructions and a physical memory accessible to the processor, the computer system being configured as an implementation of a computer architecture suitable for switching between a trusted execution environment for executing a trusted computing process and a rich execution environment for executing a client computing process corresponding to the trusted computing process, wherein an access of the rich execution environment on the trusted execution environment is restricted and/or secured, wherein the rich execution environment and the trusted execution environment respectively are switchable between a user mode in which execution of one or more selected computer instructions for accessing the physical memory is restricted and/or secured, and a kernel mode in which execution of said computer instructions is unrestricted and/or unsecured, wherein the rich execution environment and the trusted execution environment commonly use a shared memory of the physical memory, the shared memory providing a communication channel including related process data for communication between the client computing process and the trusted computing process, the method comprising:
a) by the computing device, providing a restricted memory, wherein the access to the restricted memory is restricted and/or secured with respect to the processor;
b) by the computer system, upon receiving a computer instruction for switching from the user mode to the kernel mode inside the rich execution, triggering the computing device to perform the following:
α) transferring the related process data from the shared memory into the restricted memory by clearing the related process data in the shared; and
c) by the computing device, performing step α).

2. The method according to claim 1, further comprising:
d) by the computer system, upon receiving a computer instruction for switching from the kernel mode of the trusted execution environment to the kernel mode of the rich execution environment, triggering the computing device to perform step α); and
e) by the computing device, performing step α).

3. The method according to claim 1, further comprising:
f) storing a physical location for localizing the communication channel in the physical memory and clearing the related process data in the shared memory by localizing the communication channel in the physical memory based on the physical location.

4. The method according to claim 1, further comprising:
g) by the computer system, upon receiving a computer instruction for switching from the kernel mode to the user mode inside the rich execution environment, triggering the computing device to perform the following:
β) transferring the related process data from the restricted memory into the communication channel of the shared memory by identifying the client computing process in the rich execution environment; and
h) by the computing device, performing step β).

5. The method according to claim 1, further comprising:
i) by the computer system, upon receiving a computer instruction for switching from the kernel mode of the rich execution environment to the kernel mode of the trusted execution environment, triggering the computing device to perform the following:
β) transferring the related process data from the restricted memory into the communication channel of the shared memory by identifying the client computing process in the rich execution environment; and
j) by the computing device, performing step β).

6. The method according to claim 4, further comprising:
k) storing a process identifier for identifying the client computing process in the rich execution environment and identifying the client computing process in the rich execution environment based on the process identifier.

7. The method according to claim 1, further comprising:
l) monitoring an integrity of a computer instruction for triggering the computing device to transfer the related process data into or out of the restricted memory, preferably by calculating a hash of said computer instruction, and transferring the related process data into or out of the restricted memory based on the monitored integrity.

8. A computing device including a computer system with a processor for executing computer instructions and a physical memory accessible to the processor, the computer system being configured as an implementation of a computer architecture suitable for switching between a trusted execution environment for executing a trusted computing process and a rich execution environment for executing a client computing process corresponding to the trusted computing process, wherein an access of the rich execution environment on the trusted execution environment is restricted and/or secured, wherein the rich execution environment and the trusted execution environment respectively are switchable between a user mode in which execution of one or more selected computer instructions for accessing the physical memory is restricted and/or secured, and a kernel mode in which execution of said computer instructions is unrestricted and/or unsecured, wherein the rich execution environment and the trusted execution environment commonly use a shared memory of the physical memory, the shared memory providing a communication channel including related process data for communication between the client computing process and the trusted computing process, wherein the computing device provides a restricted memory, wherein the access to the restricted memory is restricted and/or secured with respect to the processor, and wherein the computing device is adapted to perform the method according to claim 1.

9. The computing device according to claim 8, wherein hardware of the computing device is adapted to perform one, several or all of the following:
α) transferring the related process data from the shared memory into the restricted memory by clearing the related process data in the shared memory; and/or
β) transferring the related process data from the restricted memory into the communication channel of the shared memory by identifying the client computing process in the rich execution environment; and/or
f) storing a physical location for localizing the communication channel in the physical memory and clearing the related process data in the shared memory by localizing the communication channel in the physical memory based on the physical location; and/or
k) storing a process identifier for identifying the client computing process in the rich execution environment and identifying the client computing process in the rich execution environment based on the process identifier; and/or
l) monitoring an integrity of a computer instruction for triggering the computing device to transfer the related process data into or out of the restricted memory, preferably by calculating a hash of said computer instruction, and transferring the related process data into or out of the restricted memory based on the monitored integrity.

10. The computing device according to claim 8, wherein the computing device includes a field-programmable gate array providing the restricted memory.

11. The computing device according to claim 9, wherein the field-programmable gate array is adapted to perform one, several or all of the steps α), β), f), k), and/or l).

12. The computing device according to claim 8, wherein software of the computing device is adapted for triggering the computing device to perform the step α) and/or β).

13. The computing device according to claim 11, wherein the computer system is adapted for triggering the field-programmable gate array to perform the step α) and/or β).

14. A computer program comprising instructions which, when the program is executed by a computing device including a computer system with a processor for executing computer instructions and a physical memory accessible to the processor, the computer system being configured as an implementation of a computer architecture suitable for switching between a trusted execution environment for executing a trusted computing process and a rich execution environment for executing a client computing process corresponding to the trusted computing process, wherein an access of the rich execution environment on the trusted execution environment is restricted and/or secured, wherein the rich execution environment and the trusted execution environment respectively are switchable between a user mode in which execution of one or more selected computer instructions for accessing the physical memory is restricted and/or secured, and a kernel mode in which execution of said computer instructions is unrestricted and/or unsecured, wherein the rich execution environment and the trusted execution environment commonly use a shared memory of the physical memory, the shared memory providing a communication channel including related process data for communication between the client computing process and the trusted computing process, wherein the computing device provides a restricted memory, wherein the access to the restricted memory is restricted and/or secured with respect to the processor, cause the computing device to carry out the method according to claim 1.

15. A non-transitory computer-readable storage medium having stored thereon the computer program according to claim 14.

16. The method according to claim 5, further comprising:
k) storing a process identifier for identifying the client computing process in the rich execution environment and identifying the client computing process in the rich execution environment based on the process identifier.

17. The computing device according to claim 9, wherein the computing device includes a field-programmable gate array providing the restricted memory.

18. The computing device according to claim 10, wherein the field-programmable gate array is adapted to perform one, several or all of the steps α), β), f), k), and/or l).

19. The computing device according to claim 12, wherein the computer system is adapted for triggering the field-programmable gate array to perform the step α) and/or β).
